(19) United States
(12) Patent Application Publication
(10) Pub. No.: US 2012/0081347 A1
(43) Pub. Date: Apr. 5, 2012

(54) LOW POWER INVERSION SCHEME WITH MINIMIZED NUMBER OF OUTPUT TRANSITIONS

(75) Inventor: Taesung Kim, Los Altos, CA (US)

(73) Assignee: APPLE INC., Cupertino, CA (US)

(21) Appl. No.: 12/895,717

(22) Filed: Sep. 30, 2010

(51) Int. Cl. G09G 5/00

(52) U.S. Cl. 345/211

(57) ABSTRACT

A method and system for an inversion driving scheme for pixels in a display. Column drivers may drive first voltages to columns of a pixel array in a display during a first period of a frame and drive inverses of the first voltages to columns of the pixel array during a second period of a frame. Row drivers may alternately drive even and odd rows during the first and seconds periods. Additionally, data for display on the display may be arranged such that data is transmitted to the odd and even rows of pixels in conjunction with the alternate activation of the rows and columns. This data rearrangement may be accomplished through the use of a graphics processing unit or local frame buffer coupled with a timing controller.

### BACKGROUND

The present disclosure relates generally to control of a display in a device.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Liquid crystal displays (LCDs) are commonly used as screens or displays for a wide variety of electronic devices, including such consumer electronics as televisions, computers, and handheld devices (e.g., cellular telephones, audio and video players, gaming systems, and so forth). Such LCD devices typically provide a flat display in a relatively thin package that is suitable for use in a variety of electronic goods. In addition, such LCD devices typically use less power than comparable display technologies, making them suitable for use in battery-powered devices or in other contexts where it is desirable to minimize power usage.

LCDs typically include an LCD panel having, among other things, a liquid crystal layer and various circuitry for controlling orientation of liquid crystals within the layer to modulate an amount of light passing through the LCD panel and thereby render images on the panel. If a voltage of a single polarity is consistently applied to the liquid crystal layer, a biasing (polarization) of the liquid crystal layer may occurs such that the light transmission characteristics of the liquid crystal layer may be disadvantageously altered.

To aid in preventing this biasing of the liquid crystal layer, periodic inversion of the electric field applied to the liquid crystal layer may be utilized. Furthermore, various inversion techniques may be utilized to reduce visual artifacts caused by slight differences in the value of applied positive and negative voltages during the periodic inversion of the electric field applied to the liquid crystal layer. For example, a dot inversion method may cause each adjacent pixel location in the liquid crystal layer to be driven with a voltage opposite of its neighboring pixels over a given time frame. This technique may greatly reduce the generation of visual artifacts on the LCD, however, it may require a substantial amount of power to perform. Accordingly, there is a need for low power inversion techniques that minimize the generation of visual artifacts on an LCD.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

A method and system for driving a matrix of pixels in a display with alternating positive and negative voltages. Column drivers of a display may drive a first voltage, for example, a positive voltage, to selected rows along columns of a pixel array (matrix) in a display during a first period of time in a frame (i.e., the first half of the time required to update data for the entire matrix of pixels). The column driver may subsequently drive an inverse voltage of the first voltage to the remaining rows along the columns of the pixel array during a second period of time in the frame. That is, row drivers may alternately activate, for example, even then odd rows (or, alternatively, odd then even rows) during the first and seconds periods. In this manner, for example, odd rows driven by the first voltages may be scanned during a first period of time in a frame, while even rows driven by the inverse of the first voltage may be scanned during a second period of time in the frame. Additionally, since rows are scanned in two steps alternatively, image data may be pre-arranged before being scanned into display. That is, each of the odd and even rows of data may be grouped such that as the even rows scanned to the display followed by the odd rows, or vice versa.

### BRIEF DESCRIPTION OF THE DRAWINGS

Various aspects of this disclosure may be better understood upon reading the following detailed description and upon reference to the drawings in which:

FIG. 1 is a block diagram of an electronic device, in accordance with aspects of the present disclosure;

FIG. 2 is a perspective view of a computer in accordance with aspects of the present disclosure;

FIG. 3 is a perspective view of a handheld electronic device in accordance with aspects of the present disclosure;

FIG. 4 is an exploded view of a liquid crystal display (LCD) in accordance with aspects of the present disclosure;

FIG. 5 graphically depicts circuitry that may be found in the LCD of FIG. 4 in accordance with aspects of the present disclosure;

FIG. 6 is a block diagram representative of how the LCD of FIG. 4 receives data and drives a pixel array of the LCD in accordance with aspects of the present disclosure;

FIG. 7 is another block diagram of the electronic device of FIG. 1, in accordance with aspects of the present disclosure;

FIG. 8 is a diagram of the liquid crystal display of the electron device of FIG. 7;

FIG. 9 is a diagram of the pixel matrix of the liquid crystal display of FIG. 8;

FIG. 10 is a second diagram of the pixel matrix of the liquid crystal display of FIG. 8;

FIG. 11 is a second diagram of the liquid crystal display of the electron device of FIG. 7;

FIG. 12 is a timing diagram illustrating the operation of the elements of the of the liquid crystal display of FIG. 11; and

FIG. 13 is a second timing diagram illustrating the operation of the elements of the of the liquid crystal display of FIG. 11;

### DETAILED DESCRIPTION OF SPECIFIC EMBODIMENTS

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

Certain embodiments of the present disclosure are generally directed to reducing power consumption by an electronic display, such as an LCD, through driving a matrix of pixels in a display with alternating positive and negative voltages to aid in prevent biasing of the pixels in the display. For example, column drivers of a display may drive a first voltage, for example, a positive voltage, to selected rows of a pixel array in the display during a first period of time in a frame (i.e., the time required to update data for the entire matrix of pixels) and subsequently may drive an second (inverse) voltage of the first voltage to the remaining rows of the pixel array during a second period of time in the frame. That is, row drivers may alternately activate, for example, even and odd rows during the first and seconds periods in conjunction with the first and second voltages. In this manner, for example, odd rows driven by the first voltages may be scanned during a first period of time in a frame, while even rows driven by the inverse of the first voltage may be scanned during a second period of time in the frame. Alternatively, for example, even rows driven by the first voltages may be scanned during a first period of time in a frame, while odd rows driven by the inverse of the first voltage may be scanned during a second period of time in the frame. Additionally, data for display on the display may be arranged such that the data is transmitted to activated rows of pixels of the matrix in conjunction with the alternate activation of the rows discussed above. With these foregoing features in mind, a general description of electronic devices including a display that may use the presently disclosed technique is provided below.

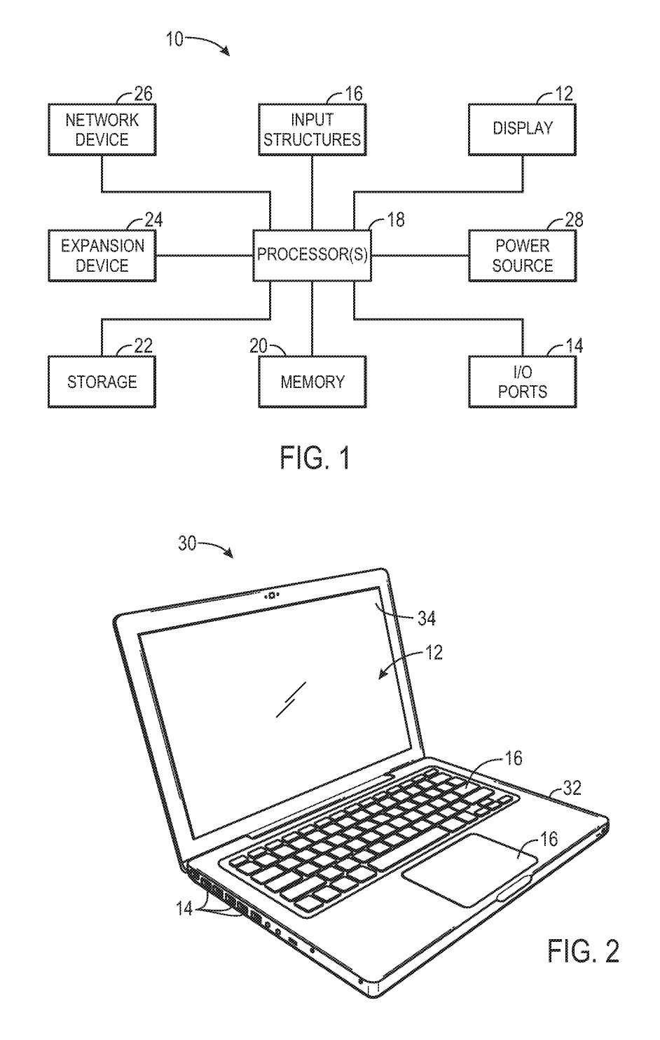

As may be appreciated, electronic devices may include various internal and/or external components which contribute to the function of the device. For instance, FIG. 1 is a block diagram illustrating components that may be present in one such electronic device 10. Those of ordinary skill in the art will appreciate that the various functional blocks shown in FIG. 1 may include hardware elements (including circuitry), software elements (including computer code stored on a computer-readable medium, such as a hard drive or system memory), or a combination of both hardware and software elements. FIG. 1 is only one example of a particular implementation and is merely intended to illustrate the types of components that may be present in the electronic device 10. For example, in the presently illustrated embodiment, these components may include a display 12, input/output (I/O) ports 14, input structures 16, one or more processors 18, one or more memory devices 20, non-volatile storage 22, expansion card(s) 24, networking device 26, and power source 28.

The display 12 may be used to display various images generated by the electronic device 10. The display 12 may be any suitable display, such as a liquid crystal display (LCD) or an organic light-emitting diode (OLED) display. Additionally, in certain embodiments of the electronic device 10, the display 12 may be provided in conjunction with a touch-sensitive element, such as a touchscreen, that may be used as part of the control interface for the device 10.

The I/O ports 14 may include ports configured to connect to a variety of external devices, such as a power source, headset or headphones, or other electronic devices (such as handheld devices and/or computers, printers, projectors, external displays, modems, docking stations, and so forth). The I/O ports 14 may support any interface type, such as a universal serial bus (USB) port, a video port, a serial connection port, an IEEE-1394 port, an Ethernet or modem port, and/or an AC/DC power connection port.

The input structures 16 may include the various devices, circuitry, and pathways by which user input or feedback is provided to processor(s) 18. Such input structures 16 may be configured to control a function of an electronic device 10, applications running on the device 10, and/or any interfaces or devices connected to or used by device 10. For example, input structures 16 may allow a user to navigate a displayed user interface or application interface. Non-limiting examples of input structures 16 include buttons, sliders, switches, control pads, keys, knobs, scroll wheels, keyboards, mice, touchpads, and so forth. Additionally, in certain embodiments, one or more input structures 16 may be provided together with display 12, such an in the case of a touchscreen, in which a touch sensitive mechanism is provided in conjunction with display 12.

Processors 18 may provide the processing capability to execute the operating system, programs, user and application interfaces, and any other functions of the electronic device 10. The processors 18 may include one or more microprocessors, such as one or more “general-purpose” microprocessors, one or more special-purpose microprocessors or ASICS, or some combination of such processing components. For example, the processors 18 may include one or more reduced instruction set (RISC) processors, as well as graphics processors, video processors, audio processors, and the like. As will be appreciated, the processors 18 may be communicatively coupled to one or more data buses or chipsets for transferring data and instructions between various components of the electronic device 10.

Programs or instructions executed by processor(s) 18 may be stored in any suitable manufacture that includes one or more tangible, computer-readable media at least collectively storing the executed instructions or routines, such as, but not limited to, the memory devices and storage devices described below. Also, these programs (e.g., an operating system) encoded on such a computer program product may also include instructions that may be executed by the processors 18 to enable device 10 to provide various functionalities, including those described herein.

The instructions or data to be processed by the one or more processors 18 may be stored in a computer-readable medium, such as a memory 20. The memory 20 may include a volatile memory, such as random access memory (RAM), and/or a non-volatile memory, such as read-only memory (ROM). The memory 20 may store a variety of information and may be used for various purposes. For example, the memory 20 may store firmware for electronic device 10 (such as basic input/output system (BIOS)), an operating system, and various other programs, applications, or routines that may be executed on electronic device 10. In addition, the memory 20 may be used for buffering or caching during operation of the electronic device 10.

The components of the device 10 may further include other forms of computer-readable media, such as non-volatile storage 22 for persistent storage of data and/or instructions. Non-volatile storage 22 may include, for example, flash memory, a hard drive, or any other optical, magnetic, and/or solid-state storage media. Non-volatile storage 22 may be used to store firmware, data files, software programs, wireless connection information, and any other suitable data.

The embodiment illustrated in FIG. 1 may also include one or more card or expansion slots. The card slots may be configured to receive one or more expansion cards 24 that may be used to add functionality, such as additional memory, I/O functionality, or networking capability, to electronic device 10. Such expansion cards 24 may connect to device 10 through any type of suitable connector, and may be accessed internally or external to the housing of electronic device 10. For example, in one embodiment, expansion cards 24 may include a flash memory card, such as a SecureDigital (SD) card, mini- or microSD, CompactFlash card, Multimedia card (MMC), or the like. Additionally, expansion cards 24 may include one or more processor(s) 18 of the device 10, such as a video graphics card having a GPU for facilitating graphical rendering by device 10.

The components depicted in FIG. 1 also include a network device 26, such as a network controller or a network interface card (NIC). In one embodiment, the network device 26 may be a wireless NIC providing wireless connectivity over any 802.11 standard or any other suitable wireless networking standard. The device 10 may also include a power source 28. In one embodiment, the power source 28 may include one or more batteries, such as a lithium-ion polymer battery or other type of suitable battery. Additionally, the power source 28 may include AC power, such as provided by an electrical outlet, and electronic device 10 may be connected to the power source 28 via a power adapter. This power adapter may also be used to recharge one or more batteries of device 10.

The electronic device 10 may take the form of a computer system or some other type of electronic device. Such computers may include computers that are generally portable (such as laptop, notebook, tablet, and handheld computers), as well as computers that are generally used in one place (such as conventional desktop computers, workstations and/or servers). In certain embodiments, electronic device 10 in the form of a computer may include a model of a MacBook®, MacBook® Pro, MacBook Air®, iMac®, Mac® mini, or Mac® Pro available from Apple Inc. of Cupertino, Calif. By way of example, an electronic device 10 in the form of a laptop computer 30 is illustrated in FIG. 2 in accordance with one embodiment. The depicted computer 30 includes a housing 32, a display 12 (e.g., in the form of an LCD 34 or some other suitable display), I/O ports 14, and input structures 16.

The display 12 may be integrated with the computer 30 (e.g., such as the display of the depicted laptop computer) or may be a standalone display that interfaces with the computer 30 using one of the I/O ports 14, such as via a DisplayPort, Digital Visual Interface (DVI), High-Definition Multimedia Interface (HDMI), or analog (D-sub) interface. For instance, in certain embodiments, such a standalone display 12 may be a model of an Apple Cinema Display®, available from Apple Inc.

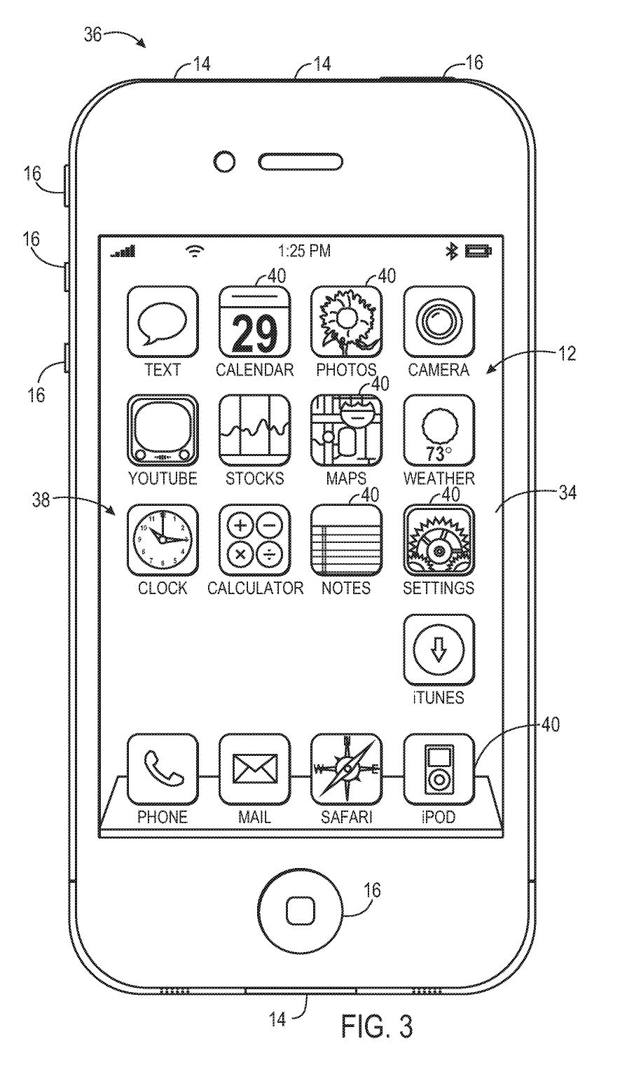

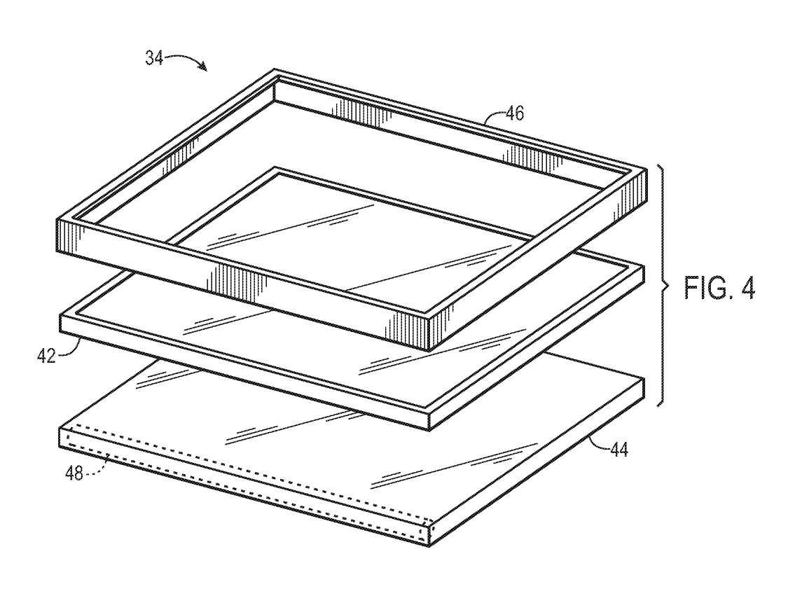

Although an electronic device 10 is generally depicted in the context of a computer in FIG. 2, an electronic device 10 may also take the form of other types of electronic devices. In some embodiments, various electronic devices 10 may include mobile telephones, media players, personal data organizers, handheld game platforms, cameras, and combinations of such devices. For instance, as generally depicted in FIG. 3, the device 10 may be provided in the form of handheld electronic device 36 that includes various functionalities (such as the ability to take pictures, make telephone calls, access the Internet, communicate via email, record audio and video, listen to music, play games, and connect to wireless networks). By way of further example, handheld device 36 may be a model of an iPod® or iPhone® available from Apple Inc.

Handheld device 36 of the presently illustrated embodiment includes a display 12, which may be in the form of an LCD 34. The LCD 34 may display various images generated by the handheld device 36, such as a graphical user interface (GUI) 38 having one or more icons 40. The device 36 may also include various I/O ports 14 to facilitate interaction with other devices, and user input structures 16 to facilitate interaction with a user.

One example of an LCD display 34 is depicted in FIG. 4 in accordance with one embodiment. The depicted LCD display 34 includes an LCD panel 42 and a backlight unit 44, which may be assembled within a frame 46. As may be appreciated, the LCD panel 42 may include an array of pixels configured to selectively modulate the amount and color of light passing from the backlight unit 44 through the LCD panel 42. For example, the LCD panel 42 may include a liquid crystal layer, one or more thin film transistor (TFT) layers configured to control orientation of liquid crystals of the liquid crystal layer via an electric field, and polarizing films, which cooperate to enable the LCD panel 42 to control the amount of light emitted by each pixel. Additionally, the LCD panel 42 may include color filters that allow specific colors of light to be emitted from the pixels (e.g., red, green, and blue).

The backlight unit 44 includes one or more light sources 48. Light from the light source 48 is routed through portions of the backlight unit 44 (e.g., a light guide and optical films) and generally emitted toward the LCD panel 42. In various embodiments, light source 48 may include a cold-cathode fluorescent lamp (CCFL), one or more light emitting diodes (LEDs), or any other suitable source(s) of light. Further, although the LCD 34 is generally depicted as having an edge-lit backlight unit 44, it is noted that other arrangements may be used (e.g., direct backlighting) in full accordance with the present technique.

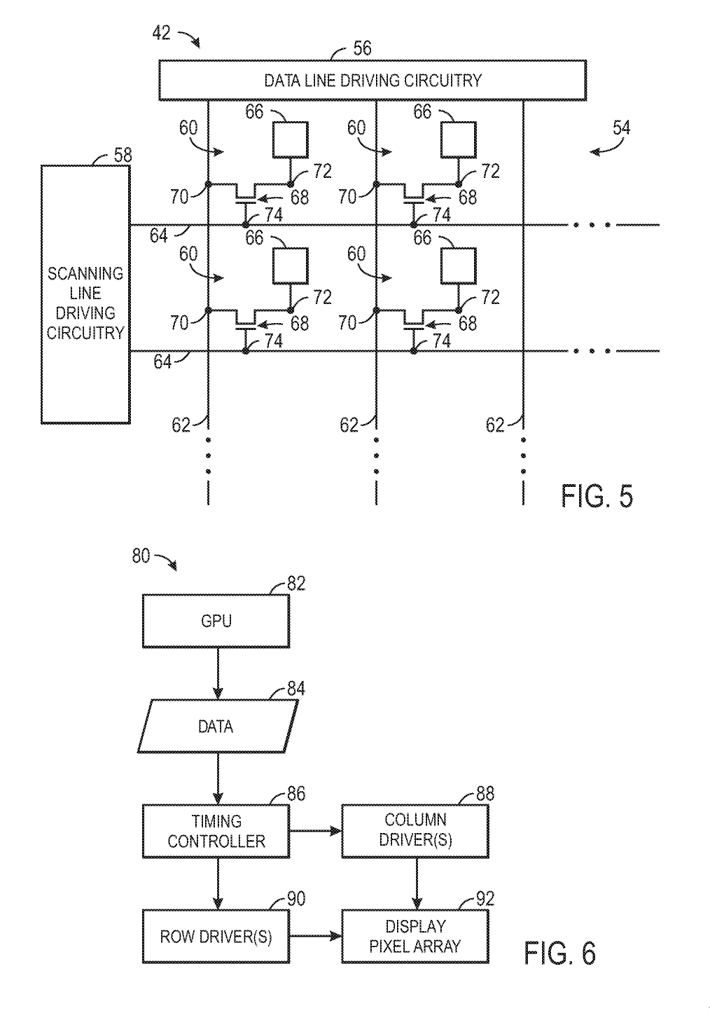

Referring now to FIG. 5, an example of a circuit view of pixel-driving circuitry found in an LCD 34 is provided. For example, the circuitry depicted in FIG. 5 may be embodied on the LCD panel 42 described above with respect to FIG. 4. The pixel-driving circuitry includes an array or matrix 54 of unit pixels 60 that are driven by data (or source) line driving circuitry 56 and scanning (or gate) line driving circuitry 58. As depicted, the matrix 54 of unit pixels 60 forms an image display region of the LCD 34. In such a matrix, each unit pixel 60 may be defined by the intersection of data lines 62 and scanning lines 64, which may also be referred to as source lines 62 and gate (or video scan) lines 64. The data line driving circuitry 56 may include one or more driver integrated circuits (also referred to as column drivers) for driving the data lines 62. The scanning line driving circuitry 58 may also include one or more driver integrated circuits (also referred to as row drivers).

Each unit pixel 60 includes a pixel electrode 66 and thin film transistor (TFT) 68 for switching the pixel electrode 66. In the depicted embodiment, the source 70 of each TFT 68 is electrically connected to a data line 62 extending from respective data line driving circuitry 56, and the drain 72 is electrically connected to the pixel electrode 66. Similarly, in the depicted embodiment, the gate 74 of each TFT 68 is electrically connected to a scanning line 64 extending from respective scanning line driving circuitry 58.

In one embodiment, column drivers of the data line driving circuitry 56 send image signals to the pixels via the respective data lines 62. Such image signals may be applied by line-sequence, i.e., the data lines 62 may be sequentially activated during operation. The scanning lines 64 may apply scanning signals from the scanning line driving circuitry 58 to the gate 74 of each TFT 68. Such scanning signals may be applied by line-sequence with a predetermined timing or in a pulsed manner.

Each TFT 68 serves as a switching element which may be activated and deactivated (i.e., turned on and off) for a predetermined period based on the respective presence or absence of a scanning signal at its gate 74. When activated, a TFT 68 may store the image signals received via a respective data line 62 as a charge in the pixel electrode 66 with a predetermined timing.

The image signals stored at the pixel electrode 66 may be used to generate an electrical field between the respective pixel electrode 66 and a common electrode. Such an electrical field may align liquid crystals within a liquid crystal layer to modulate light transmission through the LCD panel 42. Unit pixels 60 may operate in conjunction with various color filters, such as red, green, and blue filters. In such embodiments, a “pixel” of the display may actually include multiple unit pixels, such as a red unit pixel, a green unit pixel, and a blue unit pixel, each of which may be modulated to increase or decrease the amount of light emitted to enable the display to render numerous colors via additive mixing of the colors.

In some embodiments, a storage capacitor may also be provided in parallel to the liquid crystal capacitor formed between the pixel electrode 66 and the common electrode to prevent leakage of the stored image signal at the pixel electrode 66. For example, such a storage capacitor may be provided between the drain 72 of the respective TFT 68 and a separate capacitor line.

Certain components for processing image data and rendering images on an LCD 34 based on such data are depicted in block diagram 80 of FIG. 6 in accordance with an embodiment. In the illustrated embodiment, a graphics processing unit (GPU) in block 82, or some other processor 18, transmits data in block 84 to a timing controller in block 86 of the LCD 34. The data generally includes image data that may be processed by circuitry of the LCD 34 to drive pixels 60 of, and render an image on, the LCD 34. The timing controller, in block 86, may then send signals to, and control operation of, one or more column drivers (or other data line driving circuitry 56) in block 88 and one or more row drivers in block 90 (or other scanning line driving circuitry 58). These column drivers and row drivers may generate analog signals for driving the various pixels 60 of a pixel array of the LCD 34 in block 92. Additionally, in one embodiment, the data line driving circuitry 56 may include a single column driver that may be switched to drive each of a plurality of columns in the LCD 34 while the scanning line driving circuitry 58 may include a single row driver that may be switched to drive each of a plurality of rows in the LCD 34.

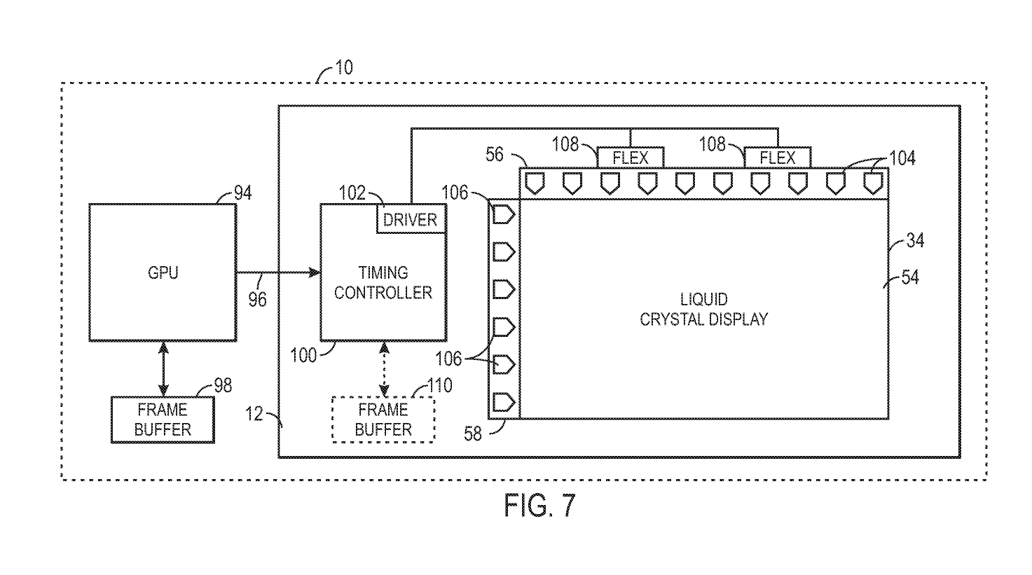

FIG. 7 illustrates an embodiment that may be utilized to implement the steps described above with respect to block diagram 80. FIG. 7 includes an illustration of device 10 that includes a graphics processing unit (GPU) 94 that may be coupled to display 12 via path 96. The GPU 94 may include one or more microprocessors, such as one or more “general-purpose” microprocessors, one or more special-purpose microprocessors or ASICS, or some combination of such processing components. In one embodiment, the GPU 94 may be separate from processor 18. Alternatively, the GPU 94 may be one of a plurality of processors included in processor 18. As noted above, the GPU 94 may be coupled to the display 12 via path 96. Path 96 may allow for data transmission between the GPU 94 and the display 12 as well allow for control signal transmission between the GPU 94 and the display 12. For example, frame data for display on the LCD 34 of the display 12 may be transmitted from the GPU 94 to the display 12. This frame data may be stored in a frame buffer 98 prior to transmission to the display 12. The data stored in the frame buffer 98 may be transmitted as an entire frame of data to be displayed at a given time on the LCD 34 (i.e., the data that will be displayed during the period of time required to transmit data to all pixels in the display 12). Alternatively, a portion of a frame of data to be displayed at a given time on the LCD 34 may be transmitted from the frame buffer 98 to the display 12.

As noted above, data, which may include image data that may be processed by circuitry of the LCD 34 to drive pixels 60 of, and render an image on, the LCD 34, may be transmitted from the GPU 94 to the display 12. This data may be received by the timing controller 100. In one embodiment, the timing controller 100 may operate to control the timing of the data line driving circuitry 56 or the scanning line driving circuitry 58 of the LCD 34. Control of the data line driving circuitry 56 or the scanning line driving circuitry 58 (which may include a single switched column driver or multiple column drivers in each of data line driving circuitry 56 and a single switched row driver or multiple row drivers in each of the scanning line driving circuitry 58) may be accomplished through generation and transmission of display signals (e.g., via a driver 102). These display signals may be based on the data received along path 96 and/or based on control signals received along path 96 and may include column driver signals transmitted to column drivers 104 in the data line driving circuitry 56 as well as gate pulse signals transmitted to the gate drivers 106 in the scanning line driving circuitry 58 of the LCD 34.

The column drivers 104 and row drivers 106 may generate analog signals for driving the various pixels 60 of a pixel array of the LCD 34. In some embodiments, the timing controller 100 may transmit data and timing signals to the column drivers 104 via, for example, one or more flex circuits 108. The column drivers 104, or other circuitry in the data line driving circuitry 56, may then forward appropriate timing or data information to the row drivers 106. In other embodiments, the timing controller 100 may directly provide timing information to each of the column drivers 104 and the row drivers 106.

Additionally, the display 12 may include a frame buffer 110 that may be utilized in place of the frame buffer 98. Frame buffer 110 may be coupled to the timing controller 100 and may be utilized to store data relating to a single frame (i.e., the period of time to transmit data to all pixels 60 in the display 12) to be displayed on the LCD 34 at a given time. The data stored in the frame buffer 110 may, for example, be retrieved by the timing controller 100 in a particular order. For example, data or timing signals relating to even numbered video scan lines 64 for a given frame may retrieved by the timing controller 100 for transmission to the LCD 34. Subsequently, data or timing signals relating to odd numbered video scan lines 64 for a given frame may retrieved by the timing controller 100 for transmission to the LCD 34. In this manner, a frame buffer 110 local to the timing controller 100 may be utilized to alter the transmission of data or timing signals to the LCD 34. It should be noted that the same process described above for modified retrieval of data from frame buffer 110 may alternatively be performed by the GPU 94 in conjunction with frame buffer 98. For example, instead of transmitting a whole frame of data to the display 12, the GPU 12 may retrieve and transmit data relating to even numbered video scan lines 64 for a given frame and subsequently may retrieve and transmit data relating to odd numbered video scan lines 64 for the LCD 34.

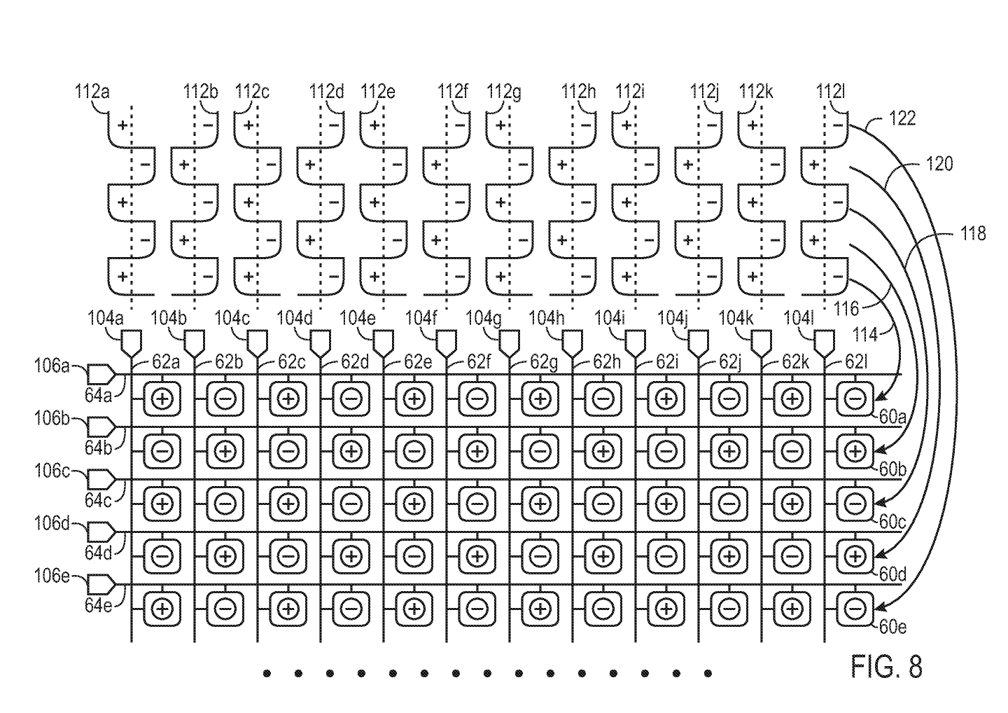

To aid in preventing biasing of the liquid crystal layer of the LCD panel 42, periodic inversion of the electric field applied to the liquid crystal layer may be utilized. For example, a dot inversion method may cause each adjacent unit pixel 60 in the liquid crystal layer to be driven with a voltage opposite of its neighboring unit pixel 60 over a given time frame. This dot inversion technique is illustrated in FIG. 8.

FIG. 8 illustrates column drivers 104a-104l and row drivers 106a-106e as well as a plurality of unit pixels 60a-60e. Each of the unit pixels 60a-60e may be coupled to a particular column driver 104l via a source line 62l and coupled to a particular row driver 106a-106e via a particular video scan line 64a-64e. As previously noted, each of the column drivers 104a-104l may be driven by a signal transmitted generated by timing controller 100 and transmitted from driver 102. Moreover, column driver outputs 112a-112l illustrate the output of the column drivers 104a-104l resulting from the signals received from the timing controller 100.

As illustrated in FIG. 8, the column driver outputs 112a-112l for each of the column drivers 104a-104l is an alternating signal that alternates between a positive and a negative value to aid in the prevention of biasing of the LCD 34. Moreover, each column driver output 112a-112l may be transmitted to each of the unit pixels 60 in a sequential manner. For example, column driver output 112l may first be a negative voltage, for example −5 volts. This value may be output from column driver 104l at a first time period during a single frame. As this negative voltage is transmitted from column driver 104l along source line 62l, a gate signal may be transmitted along video scan line 64a from row driver 106a. This may cause unit pixel 60a to be driven by the value transmitted from the column driver 104l (represented in FIG. 8 as directional arrow 114 and a negative value in unit pixel 60a). Next, the output 112l of column driver 104l may switch to a positive voltage, for example 5 volts. This value may be output from column driver 104l at a second time period immediately subsequent to the first time period during the same single frame. As this positive voltage is transmitted from column driver 104l along source line 62l, a gate signal may be transmitted along video scan line 64b from row driver 106b. This may cause unit pixel 60b to be driven by the value transmitted from the column driver 104l (represented in FIG. 8 as directional arrow 116 and a positive value in unit pixel 60b). Additionally, the example output voltages mentioned above may not necessarily be absolute positive or negative values. That is, the output values may both be positive, while the relative voltage may be negative as they are applied to pixel electrodes with certain reference voltage levels. For example, if absolute the pixel voltage is 5 volts and the reference voltage is 1 volt, then the relative voltage across liquid crystal layer becomes −4 volts.

This process may be repeated for each unit pixel 60c-60e, as illustrated by directional arrows 118, 120, and 122 until each unit pixel 60a-60e has been updated with a value corresponding to a respective output of the column driver 104l. Moreover, this process may be concurrently applied across each of column drivers 104a-104l and row drivers 106a-106e. When each of the unit pixels 60 has been updated by column driver output 112a-112l, a frame (i.e., an update to the entire matrix 54 of unit pixels 60) has been completed. These frames may occur, for example at a rate of 30, 60, or more frames per second.

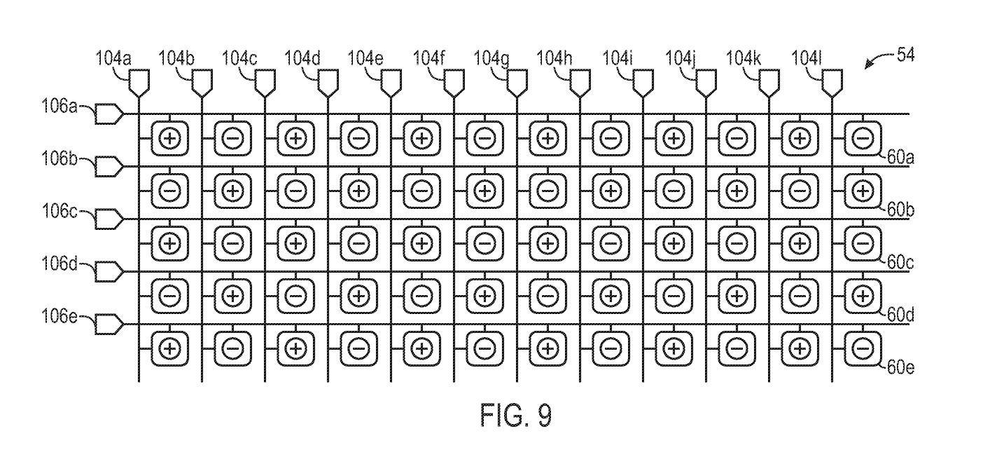

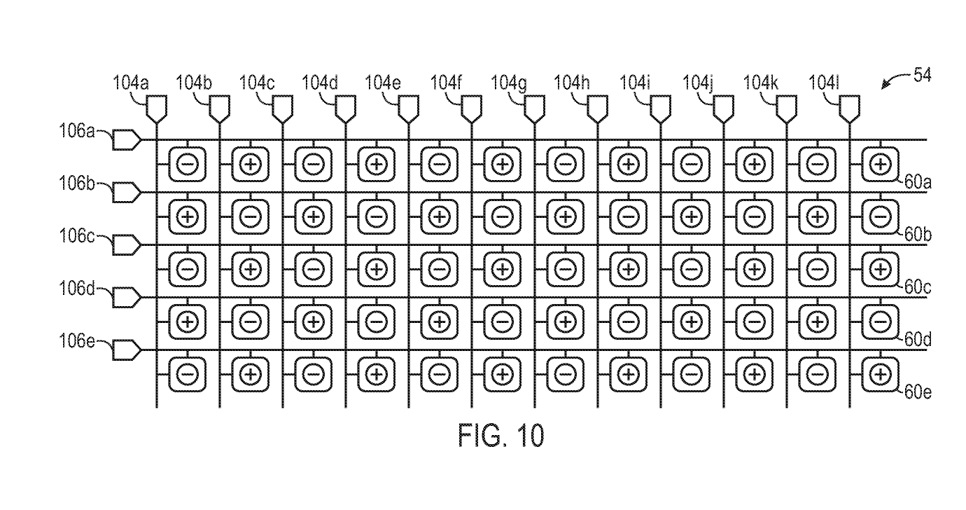

Once a frame has been completed, the column driver outputs 112a-112l may be inverted by inverting oscillating signal transmitted to the column drivers 104a-104l during a second frame immediately subsequent to the first frame. That is, in the second frame, unit pixels 60a, 60c, 60e, etc. receive positive values while unit pixels 60b, 60d, 60f, etc. receive negative values. This result is illustrated in FIGS. 9 and 10.

FIG. 9 illustrates the matrix 54 of unit pixels 60 after a first frame in which the column driver outputs 112a-112l for each of the column drivers 104a-104l is illustrated in FIG. 8. Similarly, FIG. 10 illustrates the matrix 54 of unit pixels 60 after a second frame, immediately subsequent to the first frame, in which the column driver outputs 112a-112l for each of the column drivers 104a-104l is inverse to that illustrated in FIG. 8. Moreover, the matrix 54 of unit pixels 60 in FIG. 9 may be representative of subsequent odd frames while the matrix 54 of unit pixels 60 in FIG. 9 may be representative of subsequent even frames. In this manner, the unit pixels 60 may oscillate between a positive and a negative value from one frame to the next to aid in the prevention of biasing of the LCD 34.

While the oscillation of the polarity of the unit pixels 60 in subsequent frames is desirable to aid in the prevention of biasing of the LCD 34, utilization of an oscillating signal transmitted to the column drivers 104a-104l to generate column driver outputs 112a-112l may require a substantial amount of power to drive the liquid crystals in each of the unit pixels to an alternating voltage polarity in a periodic manner. That is, each transition of the column drivers 104a-104l (each generation of an oscillation of the column driver outputs 112a-112l) consumes power at a rate higher than transmitting a positive or negative voltage from the column drivers 104a-104l at lower rate. Thus, it may be beneficial to drive unit pixels 60 of matrix 54, as illustrated in FIGS. 9 and 10, with reduced transitions by the column drivers 104a-104l.

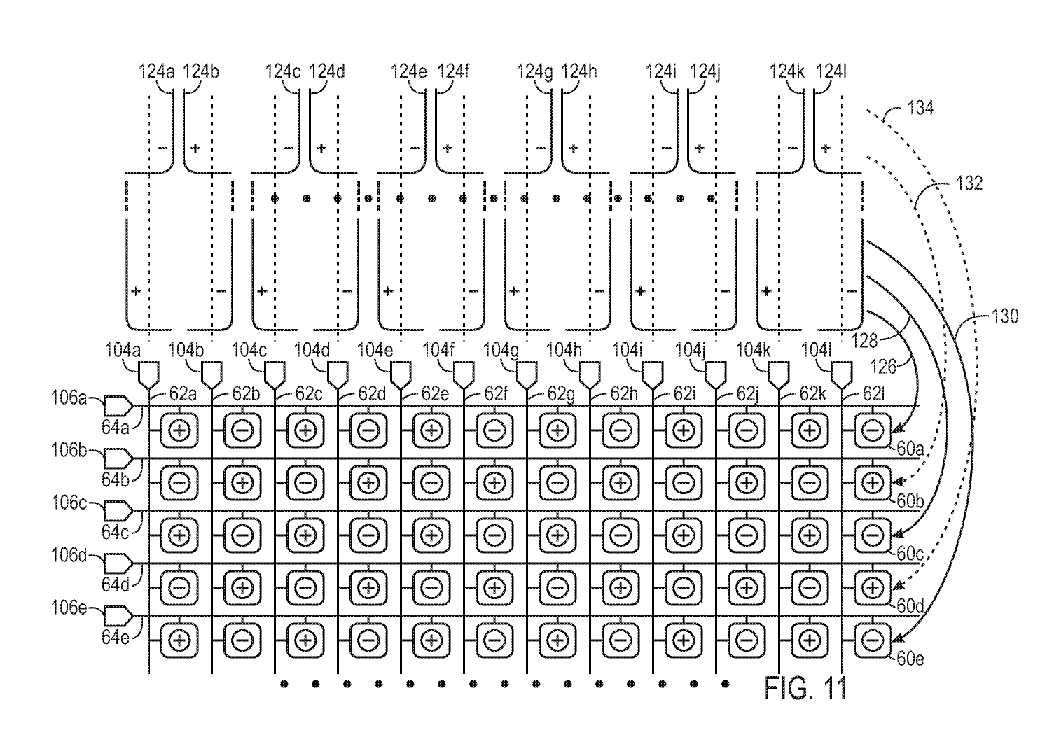

FIG. 11 illustrates a second set of column driver outputs 124a-124l for each of the column drivers 104a-104l. As illustrated, the column driver outputs 124a-124l oscillate only once per frame, i.e., the column driver outputs 124a-124l are driven to a positive voltage once and a negative voltage once per frame. In this manner, the transitions from a positive voltage to a negative voltage (or vice-versa) occur only once per frame, thus requiring less power consumption than utilized to generate column driver outputs 124a-124l. However, instead of each column driver output 124a-124l being transmitted to each of the unit pixels 60 in a sequential manner, the unit pixels 60 to be driven to negative values may, for example, receive the negative voltage column driver output (e.g., negative voltage from column driver output 124l), followed by the unit pixels 60 to be driven to positive values may, for example, receive the positive voltage column driver output (e.g., positive voltage from column driver output 124l).

For example, column driver output 124l may first be a negative voltage, for example −5 volts. This value may be output from column driver 104l at a first time period during a single frame. As this negative voltage is transmitted from column driver 104l along source line 62l, a gate signal may be transmitted along gate line 64a from row driver 106a. This may cause unit pixel 60a to be driven by the value transmitted from the column driver 104l (represented in FIG. 11 as directional arrow 126 and a negative value in unit pixel 60a). While the output 124l of column driver 104l along source line 62l remains at the negative voltage, at a second time period immediately subsequent to the first time period during the same single frame, a gate signal may be transmitted along gate line 64c from row driver 106c. This may cause unit pixel 60c to be driven by the value transmitted from the column driver 104l (represented in FIG. 11 as directional arrow 128 and a negative value in unit pixel 60c). This process may be continued for all odd rows in the matrix 54 (for example, with directional arrow 130 and a negative value in unit pixel 60e) until all of the odd rows of source line 62l have been driven to a negative voltage by a negatively driving column driver output 124l.

After all of the odd rows of source line 62l have been driven to a negative voltage by a negatively charged column driver output 124l, the column driver output 124l may be driven to a positive voltage, for example, 5 volts. This value may be output from column driver 104l at a time period immediately subsequent to the last unit pixel 60 in an odd row of the matrix 54 being driven by the column driver output 124l. As this positive voltage is transmitted from column driver 104l along source line 62l, a gate signal may be transmitted along gate line 64b from row driver 106b. This may cause unit pixel 60b to be driven by the positive value transmitted from the column driver 104l (represented in FIG. 11 as directional arrow 132 and a positive value in unit pixel 60b). This process may be repeated for unit pixel 60d, as illustrated by directional arrows 134, and all remaining even rowed unit pixels 60 until each unit pixel 60 in the matrix 54 has been updated with a value corresponding to a respective output of the column driver 104l. Moreover, this process may be concurrently applied across each of column drivers 104a-104l and row drivers 106a-106e. Additionally, this process may be altered such that the odd rows of the matrix 54 are driven to a positive value during a first period of time in a frame first while the even rows are driven to a negative voltage during a second period of time in a frame, which is then reversed for the subsequent frame. Or, for example, the even rows of the matrix 54 may be driven to a first voltage (either positive or negative) during a first period of time in a frame first while the odd rows are driven to an opposite voltage of the first voltage (either negative or positive) during a second period of time in the frame, which is then reversed for the subsequent frame.

When each of the unit pixels 60 has been updated by column driver output 124a-124l, a frame (i.e., an update of data to the entire matrix 54 of unit pixels 60) has been completed. These frames may occur, for example at a rate of 30, 60, or more frames per second. This may occur for each of the column drivers 104a-104l such that the matrix 54 includes unit pixels 60 each driven to an opposite polarity of its immediately row and column adjacent unit pixels 60. Moreover, the image data to be displayed may be pre-arranged before being scanned into display 34. That is, each of the odd and even rows of data may be grouped such that as the even rows scanned to the display 34 followed by the odd rows to match with the order of gate line driving so that final image displayed is correct.

Once a frame has been completed, the column driver outputs 124a-124l may be switched back to a negative value transmitted to the even rows of the matrix 54 (including, e.g., unit pixels 60b and 60d) followed by a negative value transmitted to the odd rows of the matrix 54 (including, e.g., unit pixels 60a, 60c, and 60e) during the next frame immediately subsequent to the first frame. Alternatively, once the first frame has been completed, the column driver outputs 124a-124l may continue to transmit a positive value which may be read into the odd rows of the matrix 54 (including, e.g., unit pixels 60a, 60c, and 60e) followed by a negative value transmitted to the even rows of the matrix 54 (including, e.g., unit pixels 60b and 60d) during the next frame immediately subsequent to the first frame. In either case, in the second frame, unit pixels 60a, 60c, 60e, etc. receive positive values while unit pixels 60b, 60d, 60f, etc. receive negative values. Thus, the column driver outputs 124a-124l may be utilized to generate the identical results illustrated in matrix 54 in FIGS. 9 and 10, with reduced transitions by the column drivers 104a-104l.

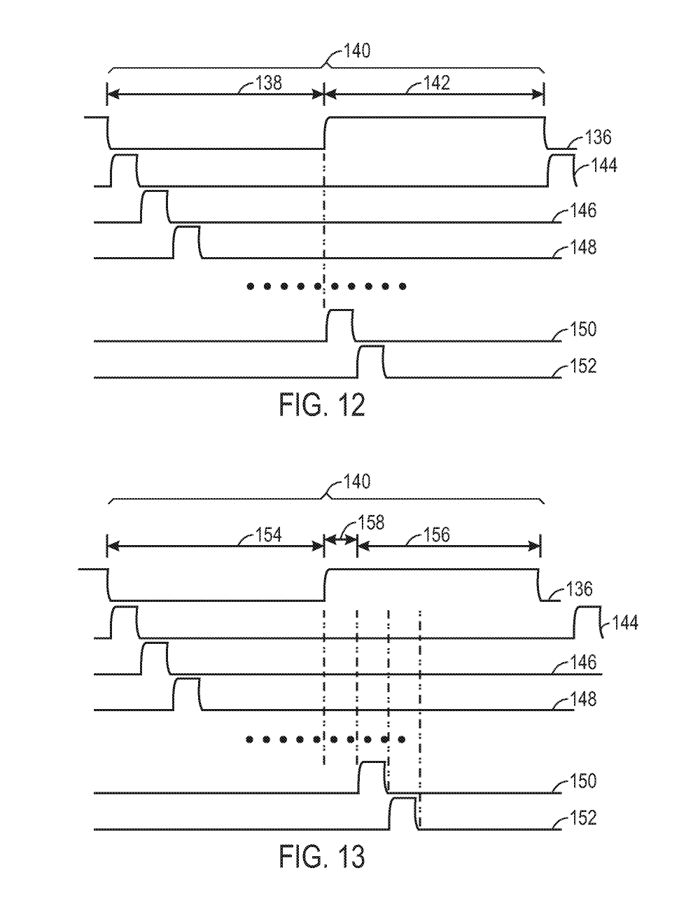

FIG. 12 illustrates a timing diagram that corresponds to FIG. 11. For example, output 136 may correspond to a column driver output, e.g., column driver output 124l. During the first half 138 of a frame 140, the output 136 may be a negative value, e.g., −5 volts. This value may be transmitted to a column driver, e.g., column driver 104l. During the first half 138 of a frame 140, various gates may be sequentially activated, represented by gate output signals 144, 146, and 148. For example, gate output signal 144 may correspond to a signal transmitted along gate line 64a from row driver 106a, gate output signal 146 may correspond to a signal transmitted along gate line 64c from row driver 106c, and gate output signal 148 may correspond to a signal transmitted along gate line 64e from row driver 106e.

At the end of the first half 138 of a frame 140, the output 138 may switch to a positive value, e.g., 5 volts. This value may also be transmitted to a column driver, e.g., column driver 104l. Thus, during the second half 142 of frame 140, various gates may be sequentially activated, as represented by gate output signals 150 and 152. For example, gate output signal 150 may correspond to a signal transmitted along gate line 64b from row driver 106b, while gate output signal 152 may correspond to a signal transmitted along gate line 64d from row driver 106d.

However, a potential problem may exist if as the output 136 switches from a negative value to a positive value, the voltage of the output 136 may not have settled to the proper (positive) level. This may cause, for example, insufficient charging of one of the unit pixels 60 driven as the output 136 is switching. FIG. 13 illustrates a timing diagram that illustrates a solution that allows all unit pixels 60 to being driven when after the output 136 has settled to its intended level. Similar to FIG. 12, output 136 of FIG. 13 may correspond to a column driver output, e.g., column driver output 124l. During a first time period 154 of a frame 140, the output 136 may be a negative value, e.g., −5 volts. This value may be transmitted to a column driver, e.g., column driver 104l. During the first half time period 154 of a frame 140, various gates may be sequentially activated, represented by gate output signals 144, 146, and 148. For example, gate output signal 144 may correspond to a signal transmitted along gate line 64a from row driver 106a, gate output signal 146 may correspond to a signal transmitted along gate line 64c from row driver 106c, and gate output signal 148 may correspond to a signal transmitted along gate line 64e from row driver 106e.

At the end of the first time period 154 of a frame 140, but prior to the final time period 156 of frame 140, may be an intermediary time period 158, which may equal, for example, the activation time for a gate output signal, e.g., signal 144. During this intermediary time period 158, no gates may be activated and either dummy data (i.e., a data value not to be displayed on the display 12) or no data may be transmitted to the LCD 34. Instead, during this intermediary time period 158, the output 136 may be allowed to settle at a positive value, for example, 5 volts.

Upon the completion of the intermediary time period 158, a final time period 156 of the frame 140 may begin, during which various gates may be sequentially activated, as represented by gate output signals 150 and 152. For example, gate output signal 150 may correspond to a signal transmitted along gate line 64b from row driver 106b, while gate output signal 152 may correspond to a signal transmitted along gate line 64d from row driver 106d. This process may be repeated for a second and any subsequent frames, as well as for each of the column drivers 104a-104l.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

What is claimed is:

1. A display comprising:
a liquid crystal display panel including an array of pixels formed into a plurality of odd rows, a plurality of even rows, a plurality of odd columns, and a plurality of even columns;
a column driver coupled to the liquid crystal display panel and configured to drive a plurality of output signals to the plurality of odd columns of the array of pixels; and
a timing controller configured to transmit a first column driver control signal to the column driver, wherein the column driver is configured to generate a first output signal of the plurality of output signals based on the column driver control signal such that the first output signal is driven to a first voltage as the first output signal is transmitted to the plurality of odd rows of the plurality of odd columns of the array of pixels and subsequently the first output signal is driven to a second voltage opposite in polarity of the first voltage as the first output signal is transmitted to the plurality of even rows of the plurality of odd columns of the array of pixels.

2. The display of claim 1, wherein the timing controller is configured to transmit a second column driver control signal to the column driver, wherein the column driver is configured to generate a second output signal based on the second column driver control signal such that the second output signal is driven to the second voltage as the output signal is transmitted to the plurality of odd rows of the even columns of the pixel array and subsequently the second output signal is driven to the first voltage as the second output signal is transmitted to the plurality of even rows of the second column of the pixel array.

3. The display of claim 2, wherein at a time subsequent to the transmission of the first and second column driver control signals, the timing controller is configured to retransmit the first and second column driver control signals to the column driver, wherein the column driver is configured to generate and transmit the first output signal to the odd columns of the array of pixels and generate and transmit the second output signal to the even columns of the array of pixels.

4. The display of claim 2, wherein the timing controller is configured to transmit the first column driver control signal and the second column driver control signal concurrently.

5. The display of claim 2, wherein the timing controller is configured to transmit the second column driver control signal immediately subsequent to transmission of the first column driver control signal.

6. The display of claim 2, comprising a respective column driver for each of the odd and even columns of the pixel array.

7. The display of claim 2, comprising a frame buffer coupled to the timing controller and configured to store image data for transmission to the liquid crystal display panel for generation of images on the display.

8. The display of claim 7, wherein the timing controller is configured to retrieve first image data from the frame buffer corresponding to pixels in the plurality of odd rows of the plurality of odd columns and subsequently retrieve image data corresponding to pixels in the plurality of even rows of the plurality of odd columns from the frame buffer.

9. The display of claim 8, wherein the timing controller is configured to retrieve second image data from the frame buffer corresponding to pixels in the plurality of odd rows of the plurality of even columns and subsequently retrieve image data corresponding to pixels in the plurality of even rows of the plurality of even columns from the frame buffer.

10. An electronic device comprising:
a graphics processing unit comprising a processor configured to generate image data and control signals; and
a display coupled to the graphics processing unit and configured to receive the image data and control signals and to display the image data, wherein the display comprises:
a liquid crystal display panel including an array of pixels formed into a plurality of odd rows, a plurality of even rows, a plurality of odd columns, and a plurality of even columns; and
a plurality column drivers, wherein each column driver is coupled to a respective one of the columns of the array of pixels, wherein the plurality of column drivers coupled to the plurality of odd columns are configured to transmit a first output signal at first voltage to the plurality of odd rows of the plurality of odd columns and subsequently transmit a second output signal at a voltage opposite in polarity of the first voltage to the plurality of even rows of the plurality of odd columns of the array of pixels.

11. The electronic device of claim 10, wherein the plurality of column drivers coupled to the plurality of even columns are configured to transmit the second output signal to the plurality of odd rows of the plurality of even columns and subsequently transmit the first output signal to the plurality of even rows of the plurality of even columns of the array of pixels.

12. The electronic device of claim 10, wherein plurality of column drivers are configured to receive the control signals from the graphics processing unit and to generate the first and second output signals based on the control signals.

13. The electronic device of claim 10, comprising a frame buffer coupled to the graphics processing unit and configured to store the image data prior to transmission to the display.

14. The electronic device of claim 12, wherein the graphics processing unit is configured to retrieve first image data from the frame buffer corresponding to pixels in the plurality of odd rows of the plurality of odd columns and subsequently retrieve image data from the frame buffer corresponding to pixels in the plurality of even rows of the plurality of odd columns.

15. The electronic device of claim 14, wherein the graphics processing unit is configured to retrieve stored dummy image data from the frame buffer subsequent to retrieving image data from the frame buffer corresponding to the pixels in the plurality of odd rows and prior to retrieving image data from the frame buffer corresponding to the pixels in the plurality of even rows for the plurality of odd columns.

16. A display comprising:
a liquid crystal display panel including an array of pixels formed into a plurality of odd rows, a plurality of even rows, a plurality of odd columns, and a plurality of even columns; and
a column driver configured to transmit a first output signal at first voltage to the plurality of odd rows of a first column of the plurality of odd columns and to subsequently transmit a second output signal at a voltage opposite in polarity of the first voltage to the plurality of even rows of the first column of the plurality of odd columns.

17. The display of claim 15, wherein the column driver is configured to transmit the second output signal to odd rows of immediately adjacent columns of the first column and to transmit the first output signal to even rows of the immediately adjacent columns of the first column.

18. The display of claim 15, wherein the column driver is configured to subsequently transmit the first output signal to the plurality of even rows of the first column of the plurality of odd columns and to subsequently transmit the second output signal to the plurality of odd rows of the first column of the plurality of odd columns.

19. A method comprising:
transmitting from a first column driver a first output signal at first voltage to a plurality of odd rows of a first column of a liquid crystal display pixel array and subsequently transmitting from the first column driver a second output signal at a voltage opposite in polarity of the first voltage to a plurality of even rows of the first column of the liquid crystal display pixel array.

20. The method of claim 19, comprising transmitting the second output signal to odd rows of immediately adjacent columns of the first column of the liquid crystal display pixel array and transmitting the first output signal to even rows of the immediately adjacent columns of the first column.

21. The method of claim 19, comprising subsequently transmitting from the first column driver the first output signal to the plurality of even rows of the first column of the plurality of odd columns and subsequently transmitting from the first column driver the second output signal to the plurality of odd rows of the first column of the plurality of odd columns.
